(19) United States
(12) Patent Application Publication
(10) Pub. No.: US 2011/0001584 A1
(43) Pub. Date: Jan. 6, 2011

(54) RADIO-FREQUENCY FILTER DEVICE USING DIELECTRIC WAVEGUIDE WITH MULTIPLE RESONANT MODES

(76) Inventor: Akira Enokihara, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/667,302

(22) PCT Filed: May 1, 2009
(86) PCT No.: PCT/JP2009/001984

§ 371 Date: Dec. 30, 2009

(30) Foreign Application Priority Data
May 1, 2008 (JP) 2008-119660

(51) Int. Cl. H01P 1/207

(52) U.S. Cl. 333/208

(57) ABSTRACT

A radio-frequency filter device is provided with: a dielectric layer, a pair of conductive layers on both surfaces of the dielectric layer, shielding via conductors short-circuiting the conductive layers, a waveguide resonator portion formed by the shielding via conductors, another conductive layer on a surface of the dielectric layer, a pair of strip conductors on the dielectric layer, a pair of input and output coupling via conductors. The coupling via conductors pass through the conductive layer and the waveguide resonator portion without contacting with the conductive layer. One end of each coupling via conductor is short-circuited to the conductive layer, and the other end is connected to one strip conductor. By inputting a radio-frequency signal, fundamental and second-order resonant modes are excited in the waveguide resonator portion.

### TECHNICAL FIELD

The present invention relates to a filter device for use in a wireless apparatus using radio-frequency signals, e.g., in a millimeter-wave band, or for use in a radio-frequency circuit for processing radio-frequency signals, e.g., in a millimeter-wave band.

### BACKGROUND ART

Filters are essential elements in radio-frequency communication systems. For example, mobile communication systems have demands for narrow-band filters for effective use of frequency bands. Moreover, base stations for mobile communication, communication satellites, etc. have strong demands for narrow-band, low-loss, and small-size filters operable even under high power. Furthermore, millimeter-wave or submillimeter-wave band wireless communication systems have been developed in recent years with conventionally used cavity waveguide filters, and these systems also have strong demands for small-size and low-loss filters.

Some of existing radio-frequency circuit elements, such as a resonator filter, utilize transmission line structure. The radio-frequency circuit elements utilizing the transmission line structure are widely used because of their small size, two-dimensional structure to be formed on a substrate, and ease of combination with other circuits and elements.

In order to obtain a cavity waveguide filter reduced in size and operable, e.g., in a millimeter-wave band, a filter using a pseudo dielectric waveguide is available, which is made of conductive layers formed on both sides of a dielectric substrate, and vias short-circuiting between the conductive layers. FIG. 13 is a perspective view showing a filter disclosed in Patent Literature 1 as an example of such a conventional filter, and FIG. 14 is a top view thereof. Referring to FIGS. 13 and 14, a front side conductor 22 is formed on one side of a dielectric substrate 21, and a back side conductor 23 is formed on an opposite side. Two rows of via holes 24 are formed along a direction of signal transmission, each via hole 24 connecting the front side conductor 22 and the back side conductor 23. A slit 26 is formed on the front side conductor 22 by partially removing the conductor, above a middle resonator. Preferably, the slit 26 is arranged perpendicular to the signal direction. Slits 27 and 28 are formed on the front side conductor 22 by partially removing the conductor, above outer resonators at both ends. A coplanar line 29 is formed on the front side conductor 22, and is connected to one of the slits 28. Preferably, each spacing L4 between via holes 24 is less than or equal to one half of the guide wavelength. This structure can be considered as a pseudo waveguide, whose cross section corresponds to a thickness of the dielectric substrate 21 (in the short side direction) by a spacing L5 between the two rows of via holes 24 (in the long side direction). In the waveguide, pairs of via holes 25 are also provided, thus forming resonators with resonant lengths L1, L2, and L3, respectively. In this case, frequencies other than a resonant frequency can be reflected by appropriately selecting a spacing L6 between a pair of via holes 25. On the other hand, signals pass through at the resonant frequency, thus achieving desired filter performance.

### CITATION LIST

### Patent Literature

PATENT LITERATURE 1: Japanese Patent Laid-open Publication No. 2002-026611.

### SUMMARY OF INVENTION

### Technical Problem

However, the filters using transmission line structure are greatly affected by conductor loss. Thus, when handling high frequency signals such as those in a millimeter-wave band, it is difficult to implement a filter with low loss or sharp characteristics.

In the case of dielectric waveguides, the problem is how to efficiently excite a resonant mode. Patent Literature 1 discloses the configuration in which coplanar lines are formed on one conductive layer, thus achieving coupling to a fundamental resonant mode by using the coplanar lines. In addition, the filter is configured by coupling the resonators each exciting only a fundamental mode, and accordingly, losses occur due to the vias 25 at positions of coupling between the resonators.

Furthermore, in the configuration disclosed in Patent Literature 1, the degree of input and output coupling is determined by a relative positional relationship between conductor patterns (e.g., the slits 27 and 28) and the set of via holes 24. Generally, as results of development in micro fabrication techniques for wiring processes and via forming processes, the accuracy in relative positions of wiring lines within a single plane or vias within a single layer has improved year by year. However, the configuration disclosed in Patent Literature 1 has a problem of being susceptible to fabrication errors. This is because alignment errors, occurring in fabrication processes of only wiring patterns or only vias, or different fabrication processes including wiring processes and via forming processes, can be serious causes of errors.

The present invention is made in view of the above-described problem, and an object of the present invention is to provide a radio-frequency filter device having low loss and being less susceptible to fabrication errors, with a simple configuration.

### Solution to Problem

According to an aspect of the present invention, a radio-frequency filter device is provided. The radio-frequency filter device is provided with: a first dielectric layer; a first conductive layer formed on a top surface of the first dielectric layer; a second conductive layer formed on a bottom surface of the first dielectric layer; a plurality of shielding via conductors formed in the first dielectric layer, each shielding via conductor short-circuiting the first and the second conductive layers, and each shielding via conductor disposed with a distance from adjacent ones less than or equal to one half of a signal wavelength in the first dielectric layer; a waveguide resonator portion formed in the first dielectric layer as a region which is surrounded by the shielding via conductors and which contains no shielding via conductors therein; a first input and output coupling via conductor formed at a first position in the waveguide resonator portion; and a second input and output coupling via conductor formed at a second position in the waveguide resonator portion different from the first position. One end of the first input and output coupling via conductor is short-circuited to one of the first and the second conductive layers, and the other end of the first input and output coupling via conductor is connected to a first input and output terminal provided to the other of the first and the second conductive layers. Further, one end of the second input and output coupling via conductor is short-circuited to one of the first and the second conductive layers, and the other end of the second input and output coupling via conductor is connected to a second input and output terminal provided to the other of the first and the second conductive layers. Thus, by inputting a radio-frequency signal to one of the first and the second input and output terminals, at least a fundamental resonant mode and a second-order resonant mode are excited in the waveguide resonator portion.

In the radio-frequency filter device, one end of the first input and output coupling via conductor is short-circuited to the first conductive layer, and the other end of the first input and output coupling via conductor is connected to the first input and output terminal provided to the second conductive layer. Further, one end of the second input and output coupling via conductor is short-circuited to the first conductive layer, and the other end of the second input and output coupling via conductor is connected to the second input and output terminal provided to the second conductive layer.

Moreover, in the radio-frequency filter device, one end of the first input and output coupling via conductor is short-circuited to the first conductive layer, and the other end of the first input and output coupling via conductor is connected to the first input and output terminal provided to the second conductive layer. Further, one end of the second input and output coupling via conductor is short-circuited to the second conductive layer, and the other end of the second input and output coupling via conductor is connected to the second input and output terminal provided to the first conductive layer.

Further, in the radio-frequency filter device, the waveguide resonator portion has a rectangular shape with a predetermined width and a predetermined length. The first and the second input and output coupling via conductors are disposed with a predetermined distance from each other, on a center line along a longitudinal direction of the waveguide resonator portion, and symmetrically to each other with respect to a center of the waveguide resonator portion. Further, the width of the waveguide resonator portion is ranged between 0.5 to 1 times the signal wavelength in the first dielectric layer. Further, the length of the waveguide resonator portion is greater than two times the width of the waveguide resonator portion. Further, the distance between the first and the second input and output coupling via conductors is greater than the width of the waveguide resonator portion.

Furthermore, in the radio-frequency filter device, by inputting a radio-frequency signal to one of the first and the second input and output terminals, at least the fundamental resonant mode, the second-order resonant mode, and a third-order resonant mode are excited in the waveguide resonator portion.

### Advantageous Effects of Invention

A radio-frequency filter device according to the present invention can achieve couplings of two or more resonant modes of a dielectric waveguide resonator at the same time, as compared to a conventional filter of a dielectric waveguide type. Thus, it is possible to achieve a two-stage filter, or multi-stage filter including a third or higher-order filter, with a simple configuration. In addition, since couplings of two or more resonant modes are achieved at the same time, it is possible to reduce the number of resonators required to achieve desired filter characteristics, and as a result, it is possible to reduce losses at via conductors in positions of coupling between resonators. Moreover, since filter characteristics are determined by a relative positional relationship between only via conductors, there is no influence of errors in pattern overlapping, and thus, an improvement in a fabrication yield ratio can be expected.

### BRIEF DESCRIPTION OF DRAWINGS

FIG. 1 is a plan view showing a configuration of a radio-frequency filter device according to a first preferred embodiment of the present invention;

FIG. 2 is a cross-sectional view taken along line A-A′ of FIG. 1;

FIG. 3 is a perspective view of the filter device of FIG. 1;

FIG. 4 is a plan view showing a configuration of a radio-frequency filter device according to a second preferred embodiment of the present invention;

FIG. 5 is a cross-sectional view taken along line A-A′ of FIG. 4;

FIG. 6 is a diagram schematically depicting magnetic lines of force 13 generated by input and output coupling via conductors 10-1 and 10-2 of the radio-frequency filter device according to each of the preferred embodiments of the present invention;

FIG. 7 is a diagram schematically depicting magnetic lines of force 13 of a fundamental resonant mode (TE011 mode) excited in a waveguide resonator portion 9 of the radio-frequency filter device according to each of the preferred embodiments of the present invention;

FIG. 8 is a diagram schematically depicting magnetic lines of force 13 of a second-order resonant mode (TE012 mode) excited in the waveguide resonator portion 9 of the radio-frequency filter device according to each of the preferred embodiments of the present invention;

FIG. 9 is a diagram schematically depicting magnetic lines of force 13 of a third-order resonant mode (TE013 mode) excited in the waveguide resonator portion 9 of the radio-frequency filter device according to each of the preferred embodiments of the present invention;

FIG. 10 is a graph showing an example of actual measurement of frequency response characteristics of a radio-frequency filter device according to Example 1 of the first preferred embodiment of the present invention;

FIG. 11 is a graph showing an example of actual measurements of frequency response characteristics with changing a distance D between input and output coupling via conductors 10-1 and 10-2 of the radio-frequency filter device according to Example 1 of the first preferred embodiment of the present invention;

FIG. 12 is a graph showing an example of actual measurement of frequency response characteristics of a radio-frequency filter device according to Example 2 of the first preferred embodiment of the present invention;

FIG. 13 is a perspective view of a conventional filter; and

FIG. 14 is a top view of the filter of FIG. 13.

### DESCRIPTION OF EMBODIMENTS

Preferred embodiments of the present invention will be described below with reference to the drawings.

### First Preferred Embodiment

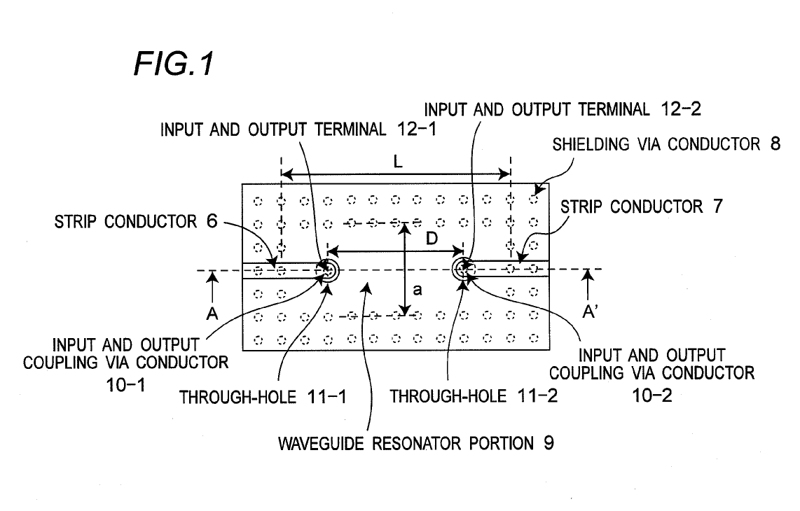

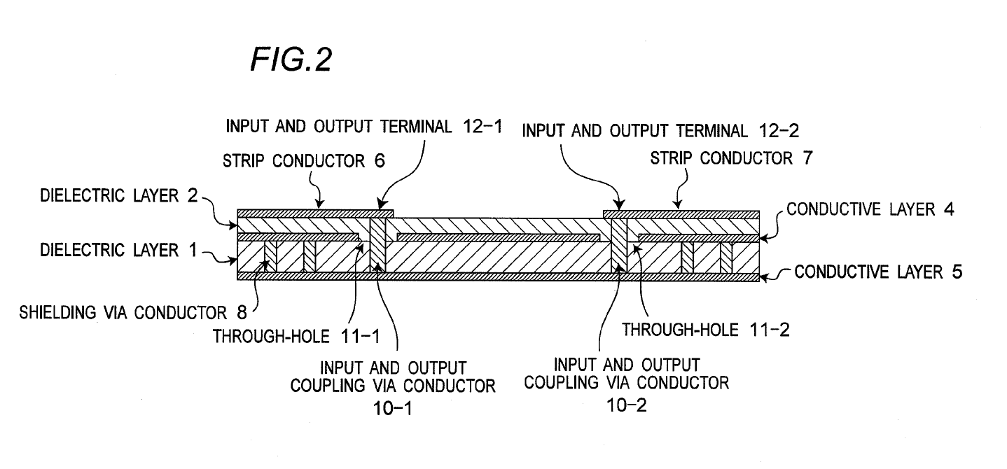

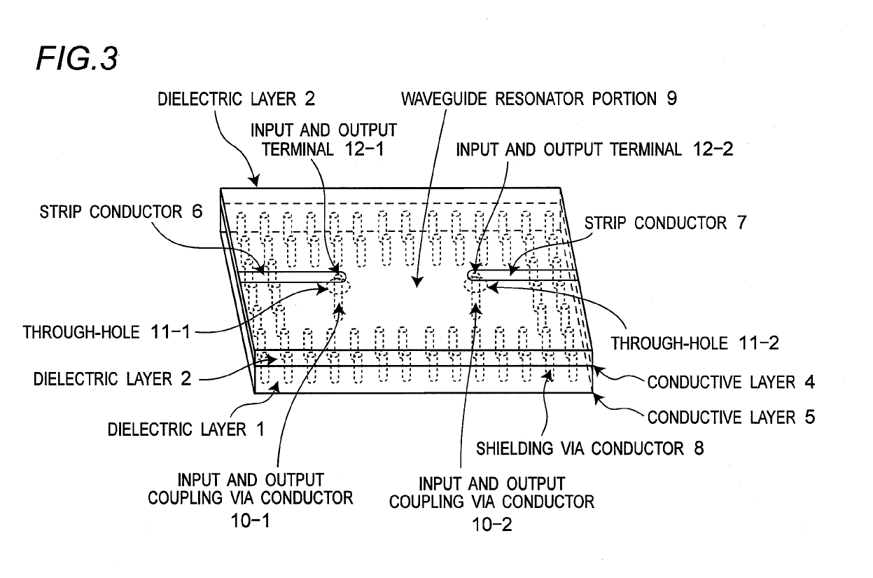

At First, a radio-frequency filter device according to a first preferred embodiment of the present invention will be described with reference to FIGS. 1 to 3. FIG. 1 is a plan view showing a configuration of a radio-frequency filter device according to the present preferred embodiment, FIG. 2 is a cross-sectional view taken along line A-A′ of FIG. 1, and FIG. 3 is a perspective view of the radio-frequency filter device.

As shown in FIGS. 1 to 3, in a radio-frequency filter device according to the present preferred embodiment, a dielectric layer 1 and a dielectric layer 2 are laminated together. On both sides of the dielectric layer 1 are formed a conductive layer 4 and a conductive layer 5, respectively. The conductive layers 4 and 5 are short-circuited by a plurality of shielding via conductors 8 formed as via conductors. In the dielectric layer 1, a waveguide resonator portion 9 is formed in a certain area of “L” by “a”, which is a region surrounded by the shielding via conductors 8 and containing no shielding via conductors 8 therein. As shown in the drawings, the shielding via conductors 8 are disposed so as to surround the waveguide resonator portion 9, and disposed with a distance from adjacent ones less than or equal to a certain distance. As long as the certain distance is less than or equal to one half of a signal wavelength to be used, the shielding via conductors 8 can operate effectively.

Furthermore, in the conductive layer 4 formed between the dielectric layers 1 and 2, through-holes 11-1 and 11-2 are formed within the waveguide resonator portion 9, with a certain distance D from each other. As an input and output port to excite resonant modes in the waveguide resonator portion 9, an input and output coupling via conductor 10-1 is provided which is a via conductor passing through the dielectric layer 2, the through-hole 11-1 formed in the conductive layer 4, and the dielectric layer 1. One end of the input and output coupling via conductor 10-1 is connected to the conductive layer 5, and the other end is connected to one end of a strip conductor 6 (shown as an input and output terminal 12-1) formed on a surface of the dielectric layer 2. Thus, the input and output coupling via conductor 10-1 is formed at a first position in the waveguide resonator portion 9 so as to short-circuit the conductive layer 5 and the strip conductor 6 without contacting with the conductive layer 4. Similarly, as another input and output port to excite resonant modes in the waveguide resonator portion 9, an input and output coupling via conductor 10-2 is provided which is a via conductor which passing through the dielectric layer 2, the through-hole 11-2 formed in the conductive layer 4, and the dielectric layer 1. One end of the input and output coupling via conductor 10-2 is connected to the conductive layer 5, and the other end is connected to one end of a strip conductor 7 (shown as an input and output terminal 12-2) formed on the surface of the dielectric layer 2. Thus, the input and output coupling via conductor 10-2 is formed at a second position in the waveguide resonator portion 9 different from the first position so as to short-circuit the conductive layer 5 and the strip conductor 7 without contacting with the conductive layer 4. The strip conductors 6 and 7, the dielectric layer 2, and the conductive layer 4 form signal lines of microstrip lines. Note that the other ends of the respective strip conductors 6 and 7 are used to input and output radio-frequency signals to and from the filter device.

By appropriately selecting the shape and dimensions of the waveguide resonator portion 9 based on a relative dielectric constant (∈ᵣ) of the dielectric layer 1 and a signal frequency to be used, a fundamental resonant mode and a second-order resonant mode can exist in the waveguide resonator portion 9. By further appropriately selecting the shape and dimensions of the waveguide resonator portion 9, a third-order resonant mode can also exist in the waveguide resonator portion 9.

Hence, by disposing a pair of the input and output coupling via conductors 10-1 and 10-2 at positions capable of coupling to the fundamental resonant mode and the second-order resonant mode, it is possible to achieve characteristics of a two-stage filter between the input and output terminals 12-1 and 12-2. In addition, by using a higher-order mode of third or higher, as a multi-stage filter, it is possible to further achieve to widen and flatten a transmission band. It can be said not only for the present configuration but also for all resonator-coupled filters that since higher-order resonant modes may exist in the higher frequency side than a desired frequency, it is possible to achieve characteristics of a normal band-pass filter by disposing the input and output coupling via conductors at positions capable of avoiding couplings to unnecessary higher-order resonant modes in a band near a pass band.

### Second Preferred Embodiment

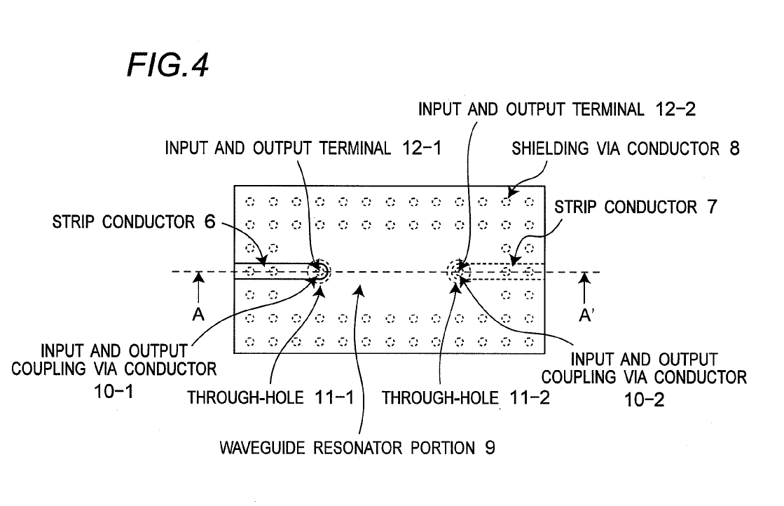

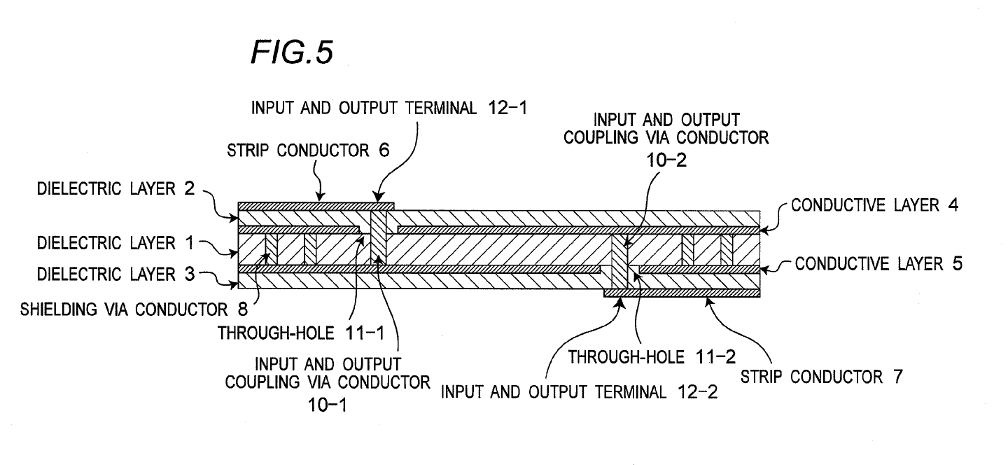

Another preferred embodiment of a radio-frequency filter device of the present invention will be described with reference to FIGS. 4 and 5. FIG. 4 is a plan view showing a configuration of a radio-frequency filter device according to the present preferred embodiment, and FIG. 5 is a cross-sectional view taken along line A-A′ of FIG. 4.

As shown in FIGS. 4 and 5, in a radio-frequency filter device according to the present preferred embodiment, a dielectric layer 1, a dielectric layer 2, and a dielectric layer 3 are laminated together. On both sides of the dielectric layer 1 are formed a conductive layer 4 and a conductive layer 5, respectively. The conductive layers 4 and 5 are short-circuited by a plurality of shielding via conductors 8 formed as via conductors. In the dielectric layer 1, a waveguide resonator portion 9 is formed in a certain area, which is a region surrounded by the shielding via conductors 8 and containing no shielding via conductors 8 therein. As shown in the drawings, the shielding via conductors 8 are disposed so as to surround the waveguide resonator portion 9, and disposed with a distance from adjacent ones less than or equal to a certain distance. As long as the certain distance is less than or equal to one half of a signal wavelength to be used, in the dielectric layer, the shielding via conductors 8 can operate effectively.

Furthermore, as an input and output port to excite resonant modes in the waveguide resonator portion 9, an input and output coupling via conductor 10-1 is provided which is a via conductor passing through the dielectric layer 2, the through-hole 11-1 formed in the conductive layer 4, and the dielectric layer 1. One end of the input and output coupling via conductor 10-1 is connected to the conductive layer 5, and the other end is connected to one end of a strip conductor 6 (shown as an input and output terminal 12-1) formed on a surface of the dielectric layer 2. Thus, the input and output coupling via conductor 10-1 is formed at a first position in the waveguide resonator portion 9 so as to short-circuit the conductive layer 5 and the strip conductor 6 without contacting with the conductive layer 4. The strip conductor 6, the dielectric layer 2, and the conductive layer 4 form a signal line of a microstrip line. Moreover, as another input and output port to excite resonant modes in the waveguide resonator portion 9, an input and output coupling via conductor 10-2 is provided which is a via conductor passing through the dielectric layer 3, a through-hole 11-2 formed in the conductive layer 5, and the dielectric layer 1. One end of the input and output coupling via conductor 10-2 is connected to the conductive layer 4, and the other end is connected to one end of a strip conductor 7 (shown as an input and output terminal 12-2) formed on a surface of the dielectric layer 3. Thus, the input and output coupling via conductor 10-2 is formed at a second position in the waveguide resonator portion 9 different from the first position so as to short-circuit the conductive layer 4 and the strip conductor 7 without contacting with the conductive layer 5. The strip conductor 7, the dielectric layer 3, and the conductive layer 5 form a signal line of a microstrip line. Note that the other ends of the respective strip conductors 6 and 7 are used to input and output radio-frequency signals to and from the filter.

By appropriately selecting the shape and dimensions of the waveguide resonator portion 9 based on a relative dielectric constant (∈ᵣ) of the dielectric layer 1 and a signal frequency to be used, a fundamental resonant mode and a second-order resonant mode can exist in the waveguide resonator portion 9. By further appropriately selecting the shape and dimensions of the waveguide resonator portion 9, a third-order resonant mode can also exist in the waveguide resonator portion 9.

Hence, by disposing the pair of the input and output coupling via conductors 10-1 and 10-2 at positions capable of coupling to the fundamental resonant mode and the second-order resonant mode, it is possible to achieve characteristics of a two-stage filter between the input and output terminals 12-1 and 12-2. In addition, by using a higher-order mode of third or higher, as a multi-stage filter, it is possible to further achieve to widen and flatten a transmission band. It can be said not only for the present configuration but also for all resonator-coupled filters that since higher-order resonant modes may exist in the higher frequency side than a desired frequency, it is possible to achieve characteristics of a normal band-pass filter by disposing the input and output coupling via conductors at positions capable of avoiding couplings to unnecessary higher-order resonant modes in a band near a pass band.

Now, a more preferred configuration in the first and second preferred embodiments will be described.

Preferably, the waveguide resonator portion 9 is of a rectangular shape, as shown in FIGS. 1 to 5. Assuming a rectangle with a width “a” and a length “L”, the waveguide resonator portion 9 can be considered as a resonator in which a rectangular waveguide with the width “a” is terminated at the length “L”. The lowest-order propagation mode of such a waveguide is a TE01 propagation mode. In order to achieve normal operation as a waveguide, it is desirable that in a frequency range to be used, the TE01 propagation mode be not cut off and a second-order propagation mode (TE02 propagation mode) or higher be cut off. Assuming that a signal frequency to be used is “f” and a relative dielectric constant of the dielectric layer 1 to be used is “Er”, a range of a desired width “a” of the waveguide resonator portion 9 is as follows:

$$\begin{matrix}\frac{λ}{2} < a < λ & ( 1 ) \\ λ = \frac{{c}_{0}}{f √ ɛ} & ( 2 )\end{matrix}$$

“λ” is a wavelength of an electromagnetic wave at the frequency “f” propagating in a medium with the relative dielectric constant “∈ᵣ”, and “c₀” is the speed of light in vacuum.

Both ends of the waveguide resonator portion 9 are short-circuited, and thus, the fundamental resonant mode is a TE011 resonant mode and the second-order resonant mode is a TE012 resonant mode. Therefore, preferably, the length “L” of the waveguide resonator portion 9 satisfies L>2a, so that at least the TE012 resonant mode can exist in the signal frequency range to be used.

When the length “L” of the waveguide resonator portion 9 exceeds five times the width “a”, resonant frequencies in higher-order resonant modes of third or higher approach the frequency to be used. If it is not desirable to include higher-order resonant modes of third or higher in a pass band, then it is desirable to further satisfy L<5a.

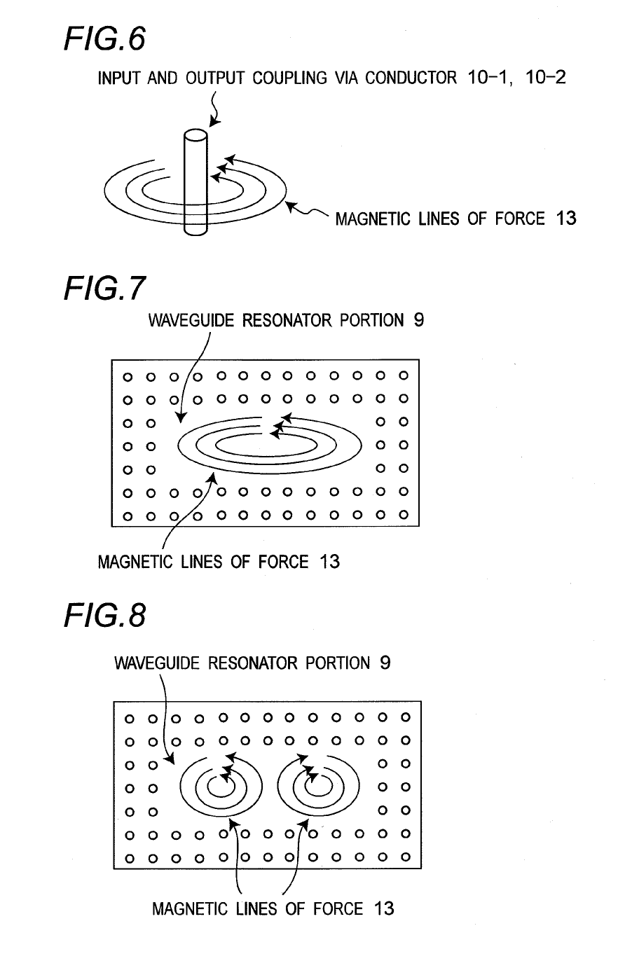

Since the input and output coupling via conductors 10-1 and 10-2 are directly short-circuited to the conductive layer(s) within the waveguide resonator portion 9, short-circuit currents flowing through the via conductors produce strong magnetic fields in a direction of rotating around the via conductors within the waveguide resonator portion 9, as shown in FIG. 6. A requirement for input and output coupling is to excite both the TE011 mode and the TE012 mode by the magnetic fields, and preferably, to achieve more equal couplings to both modes. FIGS. 7 and 8 schematically show magnetic field distributions of the TE011 mode (FIG. 7) and the TE012 mode (FIG. 8) excited in the waveguide resonator portion 9 formed by the shielding via conductors. In the magnetic field of the TE011 mode, an eddy is generated around the center of the resonator. In the magnetic field of the TE012 mode, eddies with opposite directions are respectively generated in two subdivisions of the resonator, equally divided in the longitudinal direction of the resonator. The desired positions for the input and output coupling via conductors 10-1 and 10-2 to equally couple to both modes are such that the input and output coupling via conductors 10-1 and 10-2 are disposed on a center line of the waveguide resonator portion 9 along its longitudinal direction (i.e., on the A-A′ line as shown in FIG. 1) and symmetric to each other with respect to the center of the waveguide resonator portion 9.

With respect to the distance D between the pair of the input and output coupling via conductors 10-1 and 10-2, the smaller the distance D is, the closer the pair of the input and output coupling via conductors 10-1 and 10-2 approach to the center of the resonator, thus improving the coupling efficiency to the TE011 mode, on the other hand, the coupling efficiency to the TE012 mode decreases steeply because the rotating magnetic fields go in reverse directions at the center of the resonator. In order to achieve good couplings to both modes, it is desired that D>a.

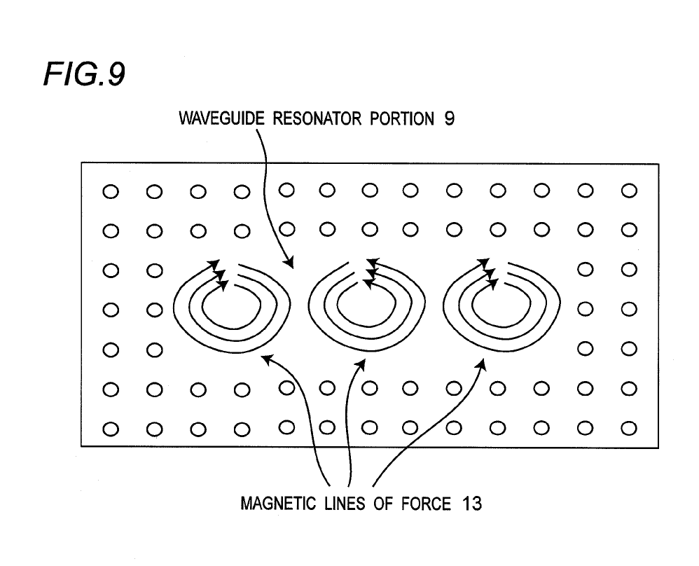

More preferably, the input and output coupling via conductors 10-1 and 10-2 further couple to a third-order resonant mode, as well as the fundamental resonant mode and the second-order resonant mode. FIG. 9 is a diagram schematically depicting magnetic lines of force 13 of the third-order resonant mode (TE013 mode) excited in the waveguide resonator portions 9 of the radio-frequency filter device according to each of the preferred embodiments of the present invention. It is possible to widen and flatten a transmission band, by exciting the fundamental resonant mode, the second-order resonant mode, and the third-order resonant mode in the waveguide resonator portion 9, and by coupling the input and output coupling via conductors 10-1 and 10-2 to these modes.

### Example 1

For a better understanding of the present invention, a specific exemplary implementation will be described.

A specific exemplary implementation of a two-stage filter in the 60 GHz band using the configuration of the first preferred embodiment is described below. A dielectric layer 1 was made using a ceramic material with a thickness of 0.2 mm and a relative dielectric constant of 8. Conductive layers 4 and 5 were made using silver coatings. Furthermore, shielding via conductors with a diameter of 0.1 mm were disposed at a distance of 0.5 mm from adjacent ones, and a waveguide resonator portion 9 was formed with a width “a=1 mm” and a length “L=3 mm”. Furthermore, a dielectric layer 2 was formed using the same ceramic material with a thickness of 0.1 mm. On the dielectric layer 2, a strip conductor 6 was formed also using silver, thus forming a microstrip line with a characteristic impedance of 50Ω. Input/output coupling via conductors 10-1 and 10-2 were disposed on a center line of the waveguide resonator portion 9 along its longitudinal direction and symmetric to each other with respect to the center of the waveguide resonator portion 9. Multiple prototypes were made with a distance D between the via conductors changed in a range of 1.6 mm to 2.2 mm.

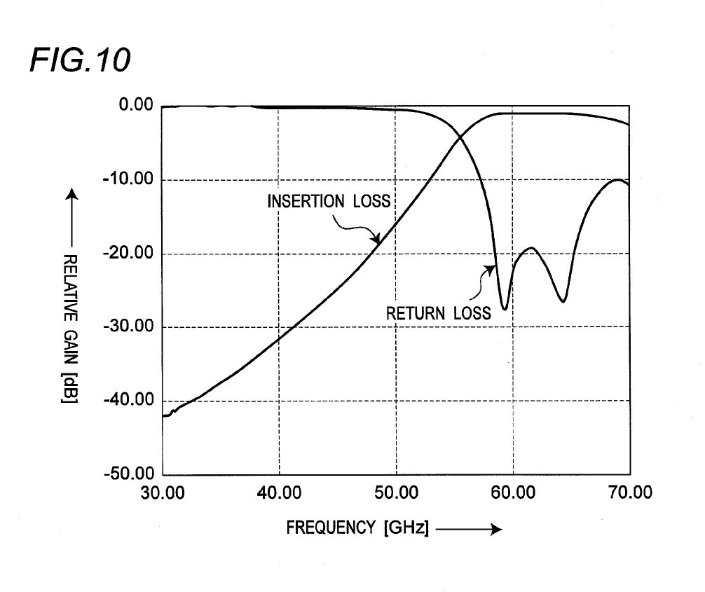

FIG. 10 shows an example of characteristics actually measured. It can be clearly seen that a reflection loss has two poles, and thus good band characteristics can be achieved. The insertion loss within the band is 2 dB or less, and thus a very low-loss characteristic is achieved. Of the two poles, a pole at a lower frequency corresponds to the TE011 resonant mode, and a pole at a higher frequency corresponds to the TE021 resonant mode. It can be seen that equal couplings to the two modes is achieved, and thus a good band characteristic is achieved. In addition, it can be seen that the attenuation increases steeply in the lower frequency bands than a pass band, since those bands are in a cut-off region of the waveguide. Accordingly, it can be said that the characteristics of FIG. 10 is very suitable for filtering of leaky waves occurring in the low frequency bands than a desired frequency, etc.

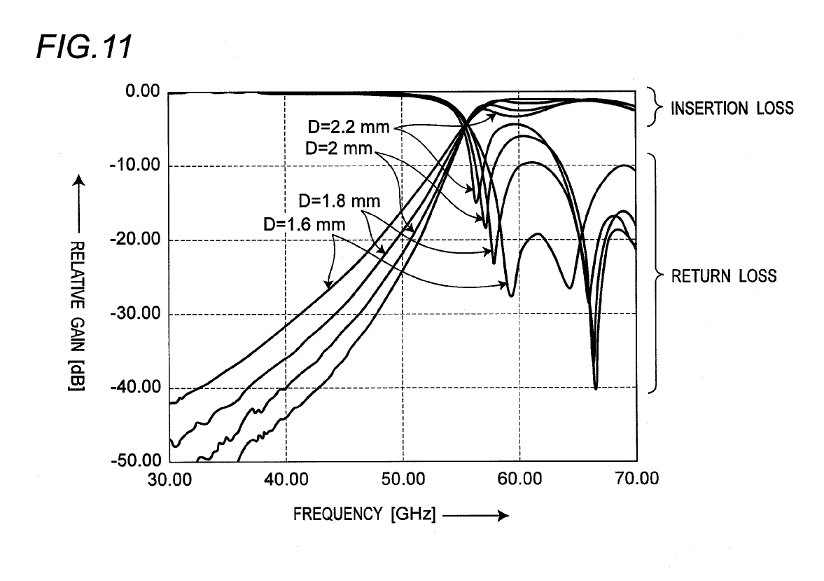

FIG. 11 shows changes in reflection loss with changing the distance D between the input and output coupling via conductors 10-1 and 10-2. As described previously, it can be seen that as the distance D decreases, the coupling to the TE011 resonant mode increases, and the coupling to the TE021 resonant mode decreases.

Note that although the specific exemplary implementation uses the ceramic material as an exemplary material for dielectric layers, the material is not limited thereto. A ceramic material and a resin material are relatively suitable, and it is also possible to use materials, such as a single crystal dielectric material, a semiconductor material, etc.

There is no theoretical limit on the frequency range available for radio-frequency filter devices according to the preferred embodiments of the present invention. However, if using a normal ceramic material or resin material and a fabrication process thereof, the range of 10 GHz to 200 GHz is actually desirable in terms of the size and fabrication accuracy of the filter.

The characterized features of radio-frequency filter devices according to the preferred embodiments of the present invention will be described. In fabrication of a filter of Patent Literature 1, alignment errors of different fabrication processes, i.e., a wiring pattern fabrication process and a via conductor forming process, are the major causes of errors. Such errors are always of a key issue when using a wiring structure and a via conductor structure at the same time in a normal element configuration with a multilayer substrate. As can be seen from FIGS. 1 to 3, in radio-frequency filter devices according to the preferred embodiments of the present invention, basic filter characteristics are determined only by a relative positional relationship between via conductors formed in and around the waveguide resonator portion 9 (i.e., the shielding via conductors 8 and the input and output coupling via conductors 10-1 and 10-2). Since via conductors in one single layer are formed at a time by a single fabrication step, their relative positional relationship can be controlled with very high accuracy. Thus, in the radio-frequency filter devices of the present invention, it is possible to fabricate a filter with good reproducibility and a high fabrication yield ratio, without being affected by alignment errors occurring in preceding fabrication processes of a multilayer substrate.

In addition, the radio-frequency filter devices of the present invention can achieve efficient coupling to two resonant modes excited in one resonator, i.e., the fundamental resonant mode and the second-order resonant mode, by means of the input and output coupling via conductors 10-1 and 10-2. In the conventional filter, a resonator is divided into a plurality of resonators each excites only a fundamental resonant mode, and the divided resonators are coupled to each other in series. On the other hand, in the preferred embodiments of the present invention, a resonator is not divided, thus avoiding losses occurring upon coupling of divided resonators. With this configuration, a low-loss filter operation can be achieved, as shown in FIG. 10.

### Example 2

Next, a specific exemplary implementation of a three-stage filter in the 60 GHz band using the configuration of the first preferred embodiment is shown below. In a radio-frequency filter device according to the present exemplary implementation, a waveguide resonator portion 9 was formed with a width “a=1.03 mm” and a length “L=3.5 mm”. A distance D between input and output coupling via conductors 10-1 and 10-2 was 1.5 mm. Other parameters were the same as those in Example 1.

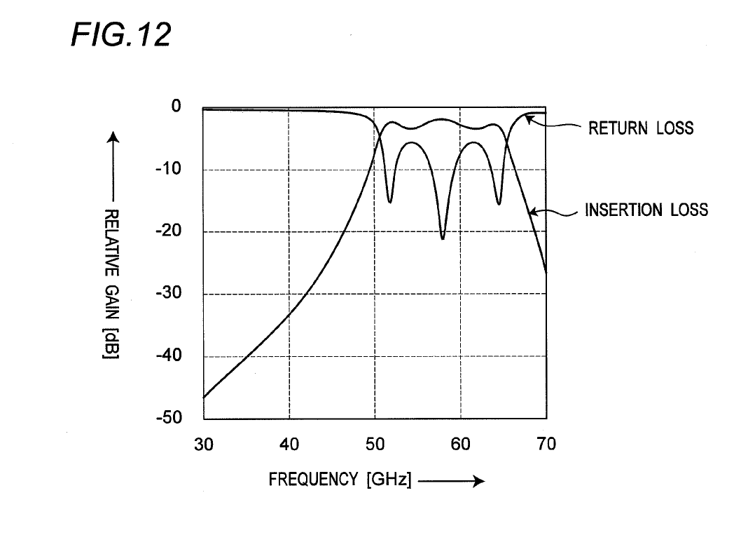

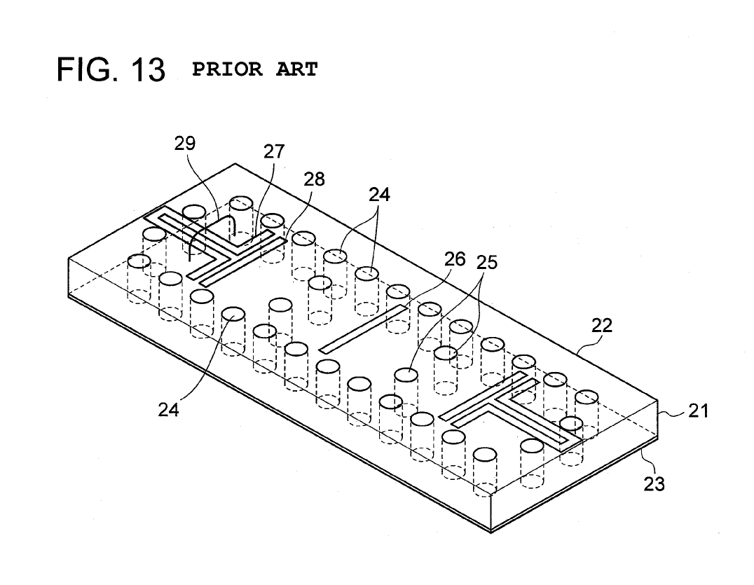

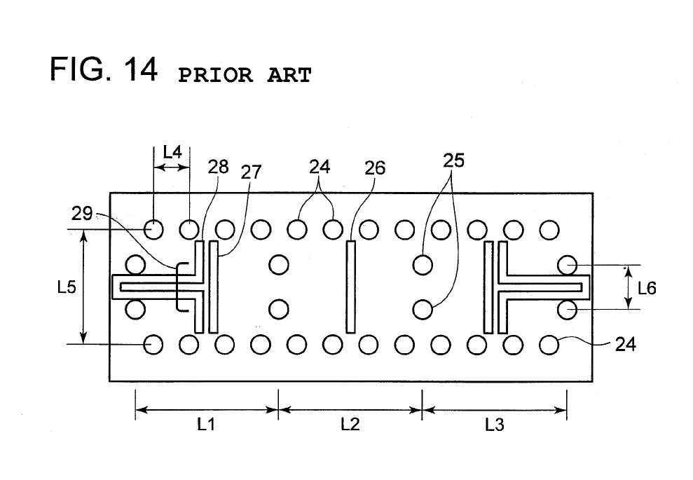

FIG. 12 shows an example of characteristics actually measured. Unlike Example 1, it can be clearly seen that a reflection loss characteristic has three poles, and thus good bandpass characteristics are achieved in a wider band. The insertion loss within the band is 3.5 dB or less.

### INDUSTRIAL APPLICABILITY

When using the configurations of radio-frequency filter devices of the present invention, a filter element is fully configured using only inner layers of a multilayer substrate. Thus, by mounting antennas and chips on a front layer of the multilayer substrate, it is possible to dramatically improve the efficiency of use of a substrate area. In addition, since there is no loss associated with coupling between stages, low loss is achieved. Furthermore, since via conductors are used for input and output coupling, filter characteristics are determined by the relative positional relationship between the via conductors. Thus, it can be characterized by the production with a high yield fabrication ratio, without being affected by errors in pattern alignment during lamination, which is always problematic with multilayer substrates.

### REFERENCE SIGNS LIST

1, 2, 3: dielectric layer,
4, 5: conductive layer,
6, 7: strip conductor,
8: shielding via conductor,
9: waveguide resonator portion,
10-1, 10-2: input and output coupling via conductor,
11-1, 11-2: through-hole,
12-1, 12-2: input and output terminal, and
13: magnetic lines of force.

1. A radio-frequency filter device comprising:
a first dielectric layer;
a first conductive layer formed on a top surface of the first dielectric layer;
a second conductive layer formed on a bottom surface of the first dielectric layer;
a plurality of shielding via conductors formed in the first dielectric layer, each shielding via conductor short-circuiting the first and the second conductive layers, and each shielding via conductor disposed with a distance from adjacent ones less than or equal to one half of a signal wavelength in the first dielectric layer;
a waveguide resonator portion formed in the first dielectric layer as a region which is surrounded by the shielding via conductors and which contains no shielding via conductors therein;
a first input and output coupling via conductor formed at a first position in the waveguide resonator portion; and
a second input and output coupling via conductor formed at a second position in the waveguide resonator portion different from the first position,
wherein one end of the first input and output coupling via conductor is short-circuited to one of the first and the second conductive layers, and the other end of the first input and output coupling via conductor is connected to a first input and output terminal provided to the other of the first and the second conductive layers,
wherein one end of the second input and output coupling via conductor is short-circuited to one of the first and the second conductive layers, and the other end of the second input and output coupling via conductor is connected to a second input and output terminal provided to the other of the first and the second conductive layers, and
wherein by inputting a radio-frequency signal to one of the first and the second input and output terminals, at least a fundamental resonant mode and a second-order resonant mode are excited in the waveguide resonator portion.

2. The radio-frequency filter device as claimed in claim 1,
wherein one end of the first input and output coupling via conductor is short-circuited to the first conductive layer, and the other end of the first input and output coupling via conductor is connected to the first input and output terminal provided to the second conductive layer, and
wherein one end of the second input and output coupling via conductor is short-circuited to the first conductive layer, and the other end of the second input and output coupling via conductor is connected to the second input and output terminal provided to the second conductive layer.

3. The radio-frequency filter device as claimed in claim 1,
wherein one end of the first input and output coupling via conductor is short-circuited to the first conductive layer, and the other end of the first input and output coupling via conductor is connected to the first input and output terminal provided to the second conductive layer, and
wherein one end of the second input and output coupling via conductor is short-circuited to the second conductive layer, and the other end of the second input and output coupling via conductor is connected to the second input and output terminal provided to the first conductive layer.

4. The radio-frequency filter device as claimed in claim 1,
wherein the waveguide resonator portion has a rectangular shape with a predetermined width and a predetermined length,
wherein the first and the second input and output coupling via conductors are disposed with a predetermined distance from each other, on a center line along a longitudinal direction of the waveguide resonator portion, and symmetrically to each other with respect to a center of the waveguide resonator portion,
wherein the width of the waveguide resonator portion is ranged between 0.5 to 1 times the signal wavelength in the first dielectric layer,
wherein the length of the waveguide resonator portion is greater than two times the width of the waveguide resonator portion, and
wherein the distance between the first and the second input and output coupling via conductors is greater than the width of the waveguide resonator portion.

5. The radio-frequency filter device as claimed in claim 1,
wherein by inputting a radio-frequency signal to one of the first and the second input and output terminals, at least the fundamental resonant mode, the second-order resonant mode, and a third-order resonant mode are excited in the waveguide resonator portion.
